(19) United States
(12) Patent Application Publication
(10) Pub. No.: US 2021/0250809 A1
(43) Pub. Date: Aug. 12, 2021

(54) EFFICIENT BANDWIDTH USAGE DURING VIDEO COMMUNICATIONS

(71) Applicant: QUALCOMM Incorporated, San Diego, CA (US)

(72) Inventors: Aniket Anil MASULE, Sangli (IN); Rajeshwar KURAPATY, Hyderabad (IN); Vikash GARODIA, Hyderabad (IN)

(21) Appl. No.: 16/786,732

(22) Filed: Feb. 10, 2020

(51) Int. Cl. H04W 28/06; H04L 29/06; H04N 19/513; H04N 19/169

(52) U.S. Cl. CPC H04W 28/06; H04N 19/188; H04N 19/513; H04L 65/40

(57) ABSTRACT

Methods, systems, and devices for efficient bandwidth usage during video communications are described. A device may estimate first motion vector information of a frame associated with a set of video frames based on a reference frame associated with the set of video frames. The reference frame may include a preceding intra-frame, a predicted-frame, or a bi-directional predicted frame in a video frame sequence. In some aspects, the device may estimate second motion vector information of the frame associated with the set of video frames based on a learning model, compare the first motion vector information and the second motion vector information using the learning model, and generate a set of video packets carrying the set of video frames including the video frame based on the comparing. In some examples, the video frame may be generated at the device or at a second device in wireless communication with the device.

### FIELD OF INVENTION

The following relates generally to video communication, and more specifically to efficient bandwidth usage during video communications.

### BACKGROUND

Some devices may provide various types of communication content such as audio (e.g., voice) and video. Some devices may support the various types of communication content, for example, such as audio and video streaming over a network (e.g., a fourth generation (4G) network such as Long Term Evolution (LTE) network, as well as a fifth generation (5G) network which may be referred to as a New Radio (NR) network). As demand for communication efficiency increases, some devices may fail to provide satisfactory streaming operations over a network, and as a result, may be unable to support high reliability or low latency communications, among other examples.

### SUMMARY

Various aspects of the described techniques relate to configuring a device to support efficient bandwidth usage during video communications. For example, the described techniques may be used to configure the device to use a learning model to reduce an amount of predicted frames (P-frames) associated with video streaming over a network (e.g., a fourth generation (4G) network or a fifth generation (5G) network), which may support high-resolution video streaming and efficient bandwidth usage of the network. In some examples, the described techniques may be used to configure the device to estimate first motion vector information (P) of a P-frame associated with a video frame sequence based on a reference frame. The reference frame may be a preceding I-frame or a P-frame in the video frame sequence. The described techniques may be used to configure the device to estimate, using a learning model (e.g., a machine learning network, a neural network, a long short-term memory (LSTM) network, or a convolutional neural network), second motion vector information (P′) of the P-frame associated with the video frame sequence.

The described techniques may be used to configure the device to compare the P′ and the P using the learning model to determine whether the P′ matches the P within a predefined threshold. If the P′ matches the P within the predefined threshold, the described techniques may be used to configure the device to not transmit the P-frame, and instead provide a discard signal. In other words, the device may encode and output the video frame sequence (generate a coded bitstream from the video frame sequence), without including the P-frame. In some examples, the described techniques may be used to configure the device to include modified headers in the coded bitstream to indicate to a second device (e.g., at a decoder perspective) that the P-frame is not included in the coded bitstream. Based on the modified headers, the second device may generate the P-frame using a learning model (e.g., a machine learning network, a neural network, a LSTM network, or a convolutional neural network) when reconstructing the video frame sequence from the coded bitstream. As such, the described techniques may include features for improvements to power consumption and, in some examples, may promote enhanced efficiency for high reliability and low latency video communications, among other benefits.

A method of video communication at a device is described. The method may include estimating first motion vector information of a frame associated with a set of video frames based on a reference frame associated with the set of video frames, where the reference frame includes a preceding intra-frame, a predicted-frame, or a bi-directional predicted frame in a video frame sequence, estimating second motion vector information of the frame associated with the set of video frames based on a learning model, comparing the first motion vector information and the second motion vector information using the learning model, and generating a set of video packets carrying the set of video frames including the video frame based on the comparing, where the video frame is generated at the device or the video frame is generated at a second device in wireless communication with the device.

An apparatus for video communication is described. The apparatus may include a processor, memory coupled with the processor, and instructions stored in the memory. The instructions may be executable by the processor to cause the apparatus to estimate first motion vector information of a frame associated with a set of video frames based on a reference frame associated with the set of video frames, where the reference frame includes a preceding intra-frame, a predicted-frame, or a bi-directional predicted frame in a video frame sequence, estimate second motion vector information of the frame associated with the set of video frames based on a learning model, compare the first motion vector information and the second motion vector information using the learning model, and generate a set of video packets carrying the set of video frames including the video frame based on the comparing, where the video frame is generated at the apparatus or the video frame is generated at a second apparatus in wireless communication with the apparatus.

Another apparatus for video communication is described. The apparatus may include means for estimating first motion vector information of a frame associated with a set of video frames based on a reference frame associated with the set of video frames, where the reference frame includes a preceding intra-frame, a predicted-frame, or a bi-directional predicted frame in a video frame sequence, estimating second motion vector information of the frame associated with the set of video frames based on a learning model, comparing the first motion vector information and the second motion vector information using the learning model, and generating a set of video packets carrying the set of video frames including the video frame based on the comparing, where the video frame is generated at the apparatus or the video frame is generated at a second apparatus in wireless communication with the apparatus.

A non-transitory computer-readable medium storing code for video communication at a device is described. The code may include instructions executable by a processor to estimate first motion vector information of a frame associated with a set of video frames based on a reference frame associated with the set of video frames, where the reference frame includes a preceding intra-frame, a predicted-frame, or a bi-directional predicted frame in a video frame sequence, estimate second motion vector information of the frame associated with the set of video frames based on a learning model, compare the first motion vector information and the second motion vector information using the learning model, and generate a set of video packets carrying the set of video frames including the video frame based on the comparing, where the video frame is generated at the device or the video frame is generated at a second device in wireless communication with the device.

In some examples of the method, apparatuses, and non-transitory computer-readable medium described herein, generating the set of video packets carrying the set of video frames may include operations, features, means, or instructions for generating, at the device, a first subset of video frames of the set of video frames based on the comparing, and refraining from generating, at the device, a second subset of video frames of the set of video frames based on the comparing, where the second subset of video frames may be generated at the second device in wireless communication with the device.

Some examples of the method, apparatuses, and non-transitory computer-readable medium described herein may further include operations, features, means, or instructions for transmitting, to the second device over a wireless connection, the set of video packets based on the generating, where transmitting the set of video packets includes transmitting, in the set of video packets, one or more of control information or data associated with each video frame of the set of video frames.

Some examples of the method, apparatuses, and non-transitory computer-readable medium described herein may further include operations, features, means, or instructions for refraining from transmitting, to the second device over a wireless connection, a subset of video frames of the set of video frames, including the frame associated with the set of video frames, based on the generating, where the refraining from transmitting the subset of video frames includes excluding data associated with each video frame of the subset of video frames, including the frame associated with the set of video frames.

Some examples of the method, apparatuses, and non-transitory computer-readable medium described herein may further include operations, features, means, or instructions for transmitting, in the set of video packets, control information associated with each video frame of the subset of video frames, including the frame associated with the set of video frames, where the control information includes header information.

In some examples of the method, apparatuses, and non-transitory computer-readable medium described herein, comparing the first motion vector information and the second motion vector information may include operations, features, means, or instructions for determining a difference between an accuracy level of the first motion vector information and an accuracy level of the second motion vector information, and determining that the difference satisfies a threshold, where generating the set of video packets may be based on the difference satisfying the threshold.

Some examples of the method, apparatuses, and non-transitory computer-readable medium described herein may further include operations, features, means, or instructions for refraining from encoding data associated with a subset of video frames of the set of video frames, including the frame associated with the set of video frames, based on the difference satisfying the threshold, and where the data associated with the subset of video frames may be generated at the second device in wireless communication with the device.

Some examples of the method, apparatuses, and non-transitory computer-readable medium described herein may further include operations, features, means, or instructions for modifying header information of the subset of video frames of the set of video frames, including the frame associated with the set of video frames, based on the comparing.

In some examples of the method, apparatuses, and non-transitory computer-readable medium described herein, modifying the header information may include operations, features, means, or instructions for appending, to the header information, an indication that the data associated with each video frame of the subset of video frames of the set of video frames, including the frame associated with the set of video frames may be discarded.

In some examples of the method, apparatuses, and non-transitory computer-readable medium described herein, the indication signals to render the data associated with each video frame of the subset of video frames, including the frame associated with the set of video frames, using the learning model.

In some examples of the method, apparatuses, and non-transitory computer-readable medium described herein, generating the set of video packets may include operations, features, means, or instructions for excluding data associated with the frame based on the comparing.

In some examples of the method, apparatuses, and non-transitory computer-readable medium described herein, the learning model includes a machine learning network, a neural network, long short-term memory (LSTM) network, or a convolutional neural network.

Some examples of the method, apparatuses, and non-transitory computer-readable medium described herein may further include operations, features, means, or instructions for receiving a second set of video packets associated with a second set of video frames, the second set of video packets including header information associated with a frame of the second set of video frames, and decoding the second set of video packets based on the header information.

In some examples of the method, apparatuses, and non-transitory computer-readable medium described herein, decoding the second set of video packets may include operations, features, means, or instructions for generating, based on the header information, data associated with the frame of the second set of video frames using the learning model.

In some examples of the method, apparatuses, and non-transitory computer-readable medium described herein, decoding the second set of video packets may include operations, features, means, or instructions for generating, based on the header information, motion vector information associated with the frame of the second set of video frames using the learning model.

### BRIEF DESCRIPTION OF THE DRAWINGS

FIGS. 1 and 2 illustrate examples of systems that support efficient bandwidth usage during video communications in accordance with aspects of the present disclosure.

FIGS. 3 and 4 illustrate examples of process flows that support efficient bandwidth usage during video communications in accordance with aspects of the present disclosure.

FIGS. 5 and 6 show block diagrams of devices that support efficient bandwidth usage during video communications in accordance with aspects of the present disclosure.

FIG. 7 shows a block diagram of a communications manager that supports efficient bandwidth usage during video communications in accordance with aspects of the present disclosure.

FIG. 8 shows a diagram of a system including a device that supports efficient bandwidth usage during video communications in accordance with aspects of the present disclosure.

FIGS. 9 and 10 show flowcharts illustrating methods that support efficient bandwidth usage during video communications in accordance with aspects of the present disclosure.

### DETAILED DESCRIPTION

Some devices may support various types of communication content, for example, such as audio or video streaming over a network (e.g., a fourth generation (4G) network such as Long Term Evolution (LTE) network, as well as a fifth generation (5G) network which may be referred to as a New Radio (NR) network). In some examples, video streaming may include encoding and decoding video data, which may include one or more of intra-predicted frames (I-frames), predicted-frames (P-frames), or bi-directional frames (B-frames). In some cases, as demand for audio or video streaming efficiency over a network increases, some devices may fail to provide satisfactory streaming operations over the network, and as a result, may be unable to support high reliability or low latency audio or video streaming, among other examples. For example, some devices may experience difficulties in high-resolution audio or video streaming over a cellular network (e.g. LTE network) due to various factors, such as a bandwidth limitation or a data rate restriction.

In some cases, some devices may use a maximizing compression (e.g., by increasing and inter-frame dependency among P-frames) to increase data rates, but may fail to utilize on-chip neural processing capabilities (e.g., neural networks). Some devices (e.g., portable devices, such as smartphones) may support video playback or video streaming related to high-resolution video (e.g., 4K resolution, 8K resolution). These devices may also support on-chip neural processing, which may leverage on-chip neural processing to improve processing of other subsystems of the devices. For devices capable of processing, transmitting, and receiving very high-resolution video, streaming of high-resolution video between devices may be limited due to maximum data rates provided by mobile networks. Techniques for efficient use of network bandwidth are desired.

In some cases, some devices may support one or more coding techniques, which may include improved codecs for achieving higher amounts of compression (e.g., frame compression), but improvements by such techniques may be inadequate, as the techniques may still include transmission of frames (e.g., as opposed to removal of the frames or frame data from encoding and transmission operations). In some other cases, some devices may support use deep-learning algorithms to predict and generate a complete frame, for example, using neural networks. Although use of deep-learning algorithms may provide improvements when encoding, transmitting, and decoding pre-trained data, the use of deep-learning algorithms may be inadequate when new data or complex data are presented. Other deep-learning algorithms include frame prediction for bandwidth or higher product capabilities, for example, using self-sufficient networks where existing architecture has not been leveraged to improve predictions for user experience. These other deep-learning algorithms may, however, include compromised user experience. Efficient usage of video hardware capability during data streaming, efficient usage of network bandwidth, and the leveraging of on-chip neural processing to enhance subsystem performance are therefore desired.

Various aspects of the described techniques relate to configuring a device to support efficient bandwidth usage during video communications. For example, the described techniques may be used to configure the device to use a learning model to reduce an amount of predicted frames (P-frames) associated with video streaming over a network (e.g., a fourth generation (4G) network or a fifth generation (5G) network), which may support high-resolution video streaming and efficient bandwidth usage of the network. In some examples, the described techniques may be used to configure the device to estimate first motion vector information (P) of a P-frame associated with a video frame sequence based on a reference frame. The reference frame may be a preceding I-frame or a P-frame in the video frame sequence. The described techniques may be used to configure the device to estimate, using a learning model (e.g., a machine learning network, a neural network, a long short-term memory (LSTM) network, or a convolutional neural network), second motion vector information (P′) of the P-frame associated with the video frame sequence.

The described techniques may be used to configure the device to compare the P′ and the P using the learning model to determine whether the P′ matches the P within a predefined threshold. If the P′ matches the P within the predefined threshold, the described techniques may be used to configure the device to not transmit the P-frame, and instead provide a discard signal. In other words, the device may encode and output the video frame sequence (generate a coded bitstream from the video frame sequence), without including the P-frame. In some examples, the described techniques may be used to configure the device to include modified headers in the coded bitstream to indicate to a second device (e.g., at a decoder perspective) that the P-frame is not included in the coded bitstream. Based on the modified headers, the second device may generate the P-frame using a learning model (e.g., a machine learning network, a neural network, a LSTM network, or a convolutional neural network) when reconstructing the video frame sequence from the coded bitstream.

Examples of aspects described herein may provide encoder enhancement and decoder enhancement by integrating deep-learning computation with video core technology. The improved methods, systems, devices, and apparatuses described herein may provide improved motion vector prediction associated with frames of a video sequence using deep-learning, for example, which may be advantageous over applying deep-learning towards complete reconstruction of the frames. In some aspects, for reconstruction of a frame of the video sequence at a decoder perspective (e.g., a receiving device), integration of deep-learning with the decoder model may provide improved accuracy. For example, integration of deep-learning with the decoder model may provide improved prediction accuracy of motion vectors associated with the frame. In some example aspects, techniques described herein may include verifying, at the encoding device, expected prediction accuracy of the decoding side. For example, the encoding device may use the learning model (e.g., a convolutional neural network) to determine whether the P′ matches the P within a predefined threshold.

Particular aspects of the subject matter described herein may be implemented to realize one or more advantages. The described methods, systems, devices, and apparatuses provide techniques which may support efficient bandwidth usage during video communications, among other advantages. As such, supported techniques may include features for using a learning model to reduce the amount of frames (e.g., P-frames) associated with video streaming over a network, which may support high-resolution video streaming and efficient bandwidth usage of the network. Additionally, the improved techniques provide for generating a first subset of video frames at a device, and refraining from generating a second subset of video frames at the device, such that the second subset of video frames may be generated at a second device in wireless communication with the device, which may support improvements to power consumption, spectral efficiency, higher data rates and, in some examples, may promote enhanced efficiency and low latency for multimedia operations (e.g., audio streaming, video streaming), among other benefits.

Aspects of the disclosure are initially described in the context of a wireless communications system. Aspects of the disclosure are further illustrated by and described with reference to apparatus diagrams, system diagrams, and process flows that relate to deep-learning integration with encoding and decoding models. The aspects described herein may provide efficient bandwidth usage during video communications supportive of video streaming over a network.

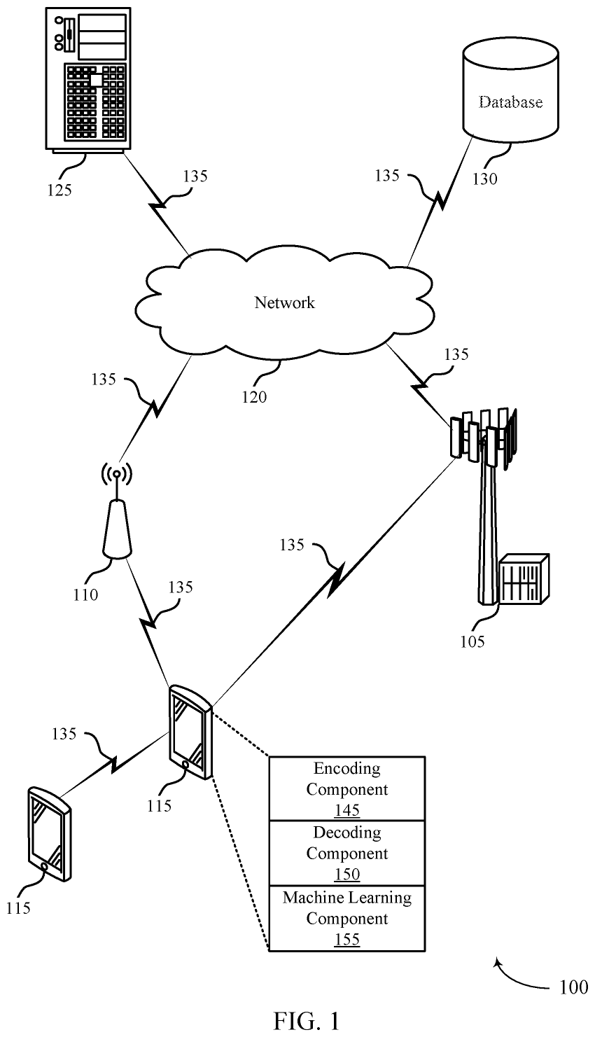

FIG. 1 illustrates an example of a system 100 that supports efficient bandwidth usage during video communications that support in accordance with aspects of the present disclosure. The system 100 may include a base station 105, an access point 110, a device 115, a server 125, and a database 130. The base station 105, the access point 110, the device 115, the server 125, and the database 130 may communicate with each other via a network 120 using communications links 135. In some examples, the system 100 may support video frame encoding and decoding using a learning model, thereby providing enhancements to communication and streaming applications (e.g., video communication and video streaming applications).

The base station 105 may wirelessly communicate with the device 115 via one or more base station antennas. The base station 105 described herein may include or may be referred to by those skilled in the art as a base transceiver station, a radio base station, a radio transceiver, a NodeB, an eNodeB (eNB), a next-generation Node B or giga-nodeB (either of which may be referred to as a gNB), a Home NodeB, a Home eNodeB, or some other suitable terminology. The device 115 described herein may be able to communicate with various types of base stations and network equipment including macro eNBs, small cell eNBs, gNBs, relay base stations, and the like. The access point 110 may be configured to provide wireless communications for the device 115 over a relatively smaller area compared to the base station 105.

The device 115 may, additionally or alternatively, include or be referred to by those skilled in the art as a user equipment (UE), a user device, a cellular phone, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the device 115 may also be able to communicate directly with another device (e.g., using a peer-to-peer (P2P) or device-to-device (D2D) protocol). The device 115 described herein may be able to communicate with another device 115, for example, via a communications link 135.

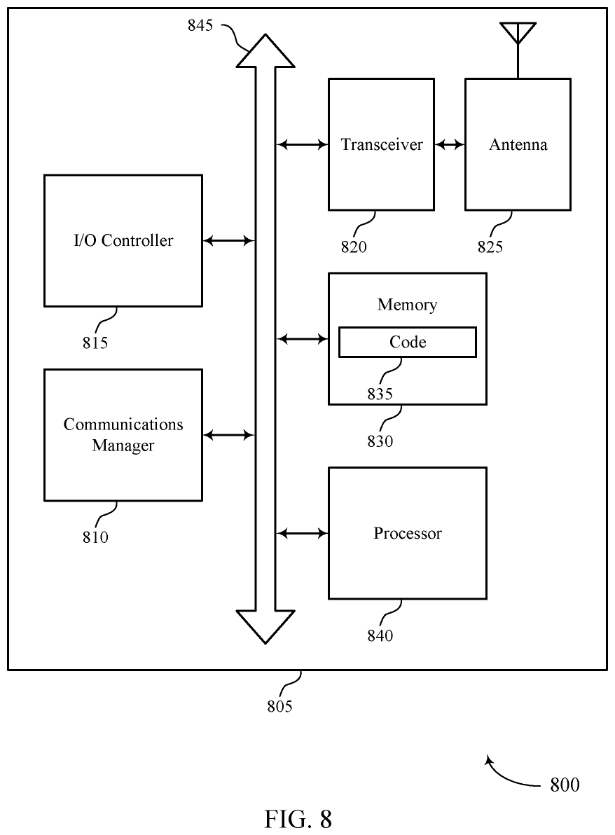

The device 115 may incorporate aspects for efficient bandwidth usage during video communications. The techniques described herein may support integration of a learning model (e.g., a machine learning network, a neural network, an LSTM network, or a convolutional neural network) with video encoding and decoding, for example, associated with streaming video over a network. The device 115 may include an encoding component 145, a decoding component 150, and a machine learning component 155. The encoding component 145, the decoding component 150, and the machine learning component 155 may be implemented by aspects of a processor, for example, such as a processor 840 described in FIG. 8. The machine learning component 155 may support a learning model, for example, a machine learning network, a neural network, a deep neural network, an LSTM network, or a convolutional neural network. The encoding component 145, the decoding component 150, and the machine learning component 155 may be implemented in a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), and/or the like.

In some examples, the device 115 may estimate first motion vector information of a frame associated with a set of video frames based on a reference frame associated with the set of video frames. The reference frame may include a preceding intra-frame, a predicted-frame, or a bi-directional predicted frame in the video frame sequence. The device 115 may estimate second motion vector information of the frame associated with the set of video frames based on the learning model (e.g., using the machine learning component 155), compare the first motion vector information and the second motion vector information using the learning model (e.g., using the machine learning component 155), and generate a set of video packets carrying the set of video frames including the video frame based on the comparing. In some aspects, the video frame may be generated at the device or the video frame may be generated at a second device 115 in wireless communication with the device 115. In some aspects, the device 115 may transmit, in the set of video packets, one or more of control information or data associated with each video frame of the set of video frames. The control information may include, for example, header information.

In some aspects, the device 115 may receive a second set of video packets associated with a second set of video frames. The second set of video packets may include header information associated with a frame of the second set of video frames. The device 115 may decode the second set of video packets based on the header information. In some aspects, the header information may include a discard signal. In some aspects, the device 115 may generate, based on the header information (e.g., the discard signal), data associated with the frame of the second set of video frames using the learning model (e.g., using the machine learning component 155). The data may include, for example, motion vector information associated with the frame of the second set of video frames.

The network 120 that may provide encryption, access authorization, tracking, Internet Protocol (IP) connectivity, and other access, computation, modification, and/or functions. Examples of the network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G) for example), etc. The network 120 may include the Internet.

The server 125 may include any combination of a data server, a cloud server, a proxy server, a mail server, a web server, an application server, a map server, a road assistance server, database server, a communications server, a home server, a mobile server, or any combination thereof. The server 125 may also transmit to the device 115 a variety of information, such as instructions or commands relevant to bandwidth usage during video communications. The database 130 may store data that may include instructions or commands related to video communications. The device 115 may retrieve the stored data from the database 130 via the base station 105 and/or the access point 110.

The communications links 135 shown in the system 100 may include uplink transmissions from the device 115 to the base station 105, the access point 110, or the server 125, and/or downlink transmissions, from the base station 105, the access point 110, the server 125, and/or the database 130 to the device 115, or between multiple devices 115. The downlink transmissions may also be called forward link transmissions while the uplink transmissions may also be called reverse link transmissions. The communications links 135 may transmit bidirectional communications and/or unidirectional communications. Communications links 135 may include one or more connections, including but not limited to, 345 MHz, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

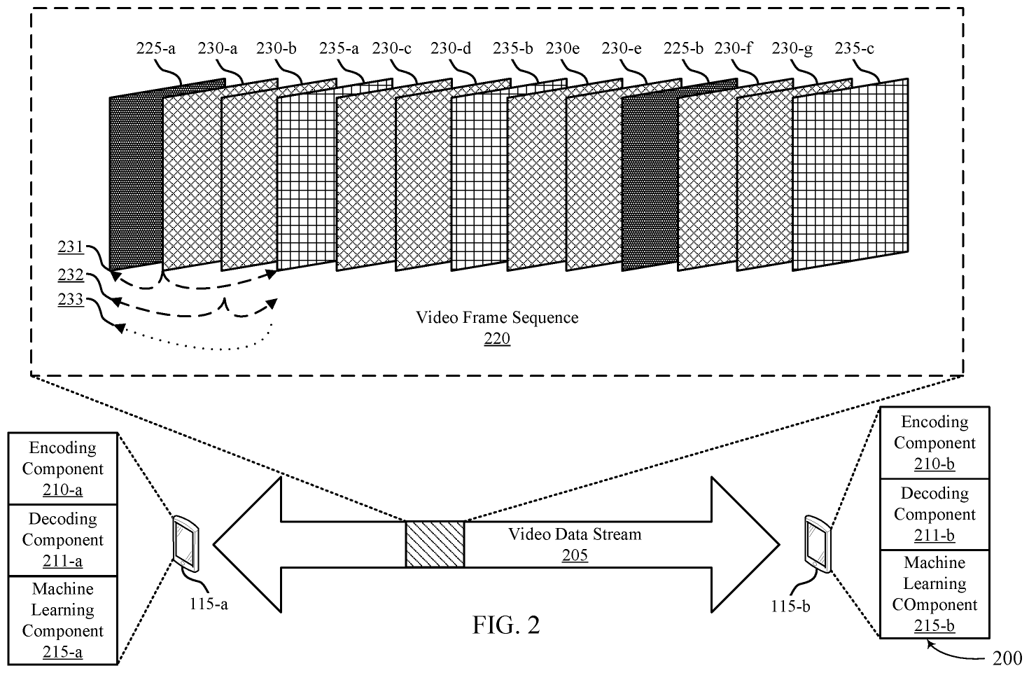

FIG. 2 illustrates an example of a system 200 for efficient bandwidth usage during video communications in accordance with aspects of the present disclosure. In some examples, the system 200 may support video frame encoding and decoding using a learning model, in accordance with aspects of the present disclosure. The system 200 may implement aspects of the system 100, such as providing improvements to video frame rendering. For example, the system 200 may include a device 115-a and a device 115-b, which may include examples of aspects of devices 115 as described with reference to FIG. 1.

The device 115-a may establish a connection with the device 115-b for video communication or video streaming over a network, for example, such as 4G systems, 5G systems, Wi-Fi systems, and the like. The connection may be a bi-directional connection between the device 115-a and the device 115-b. Each of the device 115-a and the device 115-b may include encoding components, decoding components, and a learning network. For example, the device 115-a may include an encoding component 210-a, a decoding component 211-a, and a machine learning component 215-a. In some examples, the device 115-b may include an encoding component 210-b, a decoding component 211-b, and a machine learning component 215-b. The machine learning component 215-a and the machine learning component 215-b may include examples of aspects of the machine learning component 215 described herein.

In some examples, during video communication, the device 115-a may capture video, compress (quantize) video frames of the captured video, generate a set of video packets carrying the video frames, and transmit a video data stream 205 to the device 115-b, for example, over a video connection. The device 115-a may encode (e.g., compress) video frames and packetize the encoded video frames using an encoding component 210-a. The video data stream 205 may include intra-coded frames (I-frames) 225, bidirectional predicted frames (B-frames) 230, and predicted frames (P-frames) 235. I-frames 225, B-frames 230, and P-frames 235 may be included in a video frame sequence 220.

I-frames 225 may include complete image information associated with the captured video. The I-frames 225 may be frames formatted based on an image file format, for example, a bitmap image format. For example, the I-frames may be frames formatted based on a joint photographic experts group (JPEG) format, a Windows bitmap format (BMP), or a graphics interchange format (GIF). I-frames 225 may include intra macroblocks. B-frames 230 may be bidirectional frames predicted from two reference frames. For example, B-frame 230-a and B-frame 230-b may be predicted based on a preceding reference frame (e.g., I-frame 225-a) and a following reference frame (e.g., P-frame 235-a), as indicated by the arrows at 231 and 232, respectively. In some aspects, prediction of a B-frame 230 based on a reference frame on which the B-frame 230 depends (e.g., an I-frame 225, a B-frame 230, or a P-frame 235) may follow decoding of the reference frame (e.g., out of order decoding). B-frames 230 may include intra macroblocks, predicted macroblocks, or bi-predicted macroblocks.

P-frames 235 may be frames predicted based on a preceding reference frame, for example, a preceding I-frame 225 or a preceding P-frame 235. For example, the P-frame 235-a may be predicted based on the I-frame 225-a, as indicated by the arrow at 233. In some aspects, the P-frames 235 may include motion vector information (e.g., motion displacement vector information) and may include image data. In an example, the P-frame 235-a may include changes in an image based on a preceding frame, for example, the I-frame 225-a. In an example where the video frame sequence 220 is associated with a moving object and a stationary background, the P-frames 235 (e.g., the P-frame 235-a) may include image data associated with movement of the object, without including image data associated with the stationary background (e.g., without including image data associated with unchanging or stationary background pixels). In some aspects, the P-frames 235 may be referred to as delta-frames. P-frames 235 may include intra macroblocks or predicted macroblocks.

In some aspects, the device 115-b may receive the video data stream 205 and generate a set of video frames from the video data stream 205. For example, the device 115-b may decode the video stream 205 (e.g., decode packets of the video data stream 205) using the decoding component 211-b, and in some examples, generate one or more of the I-frames 225, B-frames 230, and P-frames 235 of the video frame sequence 220 from decoding the video data stream 205. In some aspects, the device 115-b may output video frames (e.g., I-frames 225, B-frames 230, P-frames 235) for display at the device 115-b, for example, via a display of the device 115-b. Both the device 115-a and the device 115-b may encode and transmit as described herein. In some aspects, both the device 115-a and the device 115-b may receive and decode as described herein.

In some aspects, video streams including high-resolution video (e.g., 1080p, 4K resolution, 8K resolution) may result in relatively large amounts of data to be transmitted in the video streams. For example, transmitting the video data stream 205 (e.g., the I-frames 225, B-frames 230, and P-frames 235 of the video frame sequence 220) may include transmitting relatively large amounts of data over a network (e.g., the network 120), for example, when the video data stream 205 includes high-resolution video. The improved methods, systems, devices, and apparatuses described herein for efficient bandwidth usage during video communications may increase inter frame dependency among video frames in the video data stream 205 (e.g., increase inter frame dependency among the P-frames 235, for example, using integration of a learning model with an encoding model as described herein), as opposed to increasing intra frame dependency. In some aspects, through increasing the inter frame dependency among the P-frames 235, the improved methods, systems, devices, and apparatuses described herein may achieve maximum data compression for transmitting the video data stream 205.

According to examples of aspects described herein, the improved methods, systems, devices, and apparatuses may include deep-learning techniques for reducing the amount of data transferred when transmitting the video data stream 205 (e.g., the I-frames 225, B-frames 230, and P-frames 235 of the video frame sequence 220) over a network (e.g., network 100). For example, the device 115-a, when transmitting the video data stream 205, may transmit control information and data associated with a subset of frames of the video data stream 205 and transmit control information associated with another subset of frames of the video data stream 205, without transmitting data (e.g., frame data) associated with the other subset of frames of the video data stream 205. The device 115-a, for example, may use a learning model (e.g., the machine learning component 215-a) in determining whether to transmit the control information associated with the other subset of frames of the video data stream 205, without transmitting the data (e.g., frame data) associated with the other subset of frames of the video data stream 205. In some example aspects, the device 115-b may receive the video data stream 205, and using a learning network (e.g., the machine learning component 215-b), may generate the data (e.g., frame data) associated with the other subset of frames of the data stream 205 locally at the device 115-b.

In an example, the device 115-a may transmit control information and data associated with the I-frames 225 and B-frames 230 of the video stream 205. In some aspects, the device 115-a may transmit control information associated with the P-frames 235, and exclude transmitting data associated with the P-frames 235 (e.g., exclude transmitting frame data of the P-frames 235). The control information associated with the I-frames 225, B-frames 230, and P-frames 235 may be included in header information in the video stream 205. In some aspects, the control information or the header information associated with a P-frame 235 may include an indication that the data (e.g., frame data) associated with the P-frame 235 has been discarded from the video stream 205 by the device 115-a (e.g., is not included in the video stream 205). The device 115-a, for example, may use a learning model (e.g., the machine learning component 215-a) in determining whether to transmit the control information associated with the P-frames 235 and exclude transmitting the data associated with the P-frames 235 (e.g., exclude transmitting the frame data of the P-frames 235).

The device 115-b may receive the video data stream 205, and using a learning network (e.g., the machine learning component 215-b), may generate the data (e.g., frame data) associated with the P-frames 235 locally at the device 115-b (e.g., as part of, or concurrent an operation for decoding video packets of the video stream 205). In some aspects, using the learning network, the device 115-b may generate motion vector information associated with the P-frames 235. In some examples, the device 115-b may determine, based on the control information or the header information associated with the P-frames 235 (e.g., based on an indication included in the control information or the header information associated with the P-frame 235-a), whether to generate the data (e.g., frame data, motion vector information) associated with the P-frames 235. In some aspects, the device 115-a may generate and transmit the video stream 205 to the device 115-b, and the device 115-b may receive and decode the video stream 205. Alternatively or additionally, the device 115-b may generate and transmit a video stream 205 to the device 115-a, and the device 115-a may receive and decode the video stream 205. In some aspects, both the device 115-a and the device 115-b may generate and transmit a video stream 205 and receive and decode a different video stream 205 at the same time.

According to examples of aspects described herein, a device 115 (e.g., the device 115-a), may estimate first motion vector information of a frame (e.g., a P-frame 235) associated with a set of video frames (e.g., the I-frames 225, B-frames 230, and P-frames 235) based on a reference frame associated with the set of video frames, where the reference frame includes a preceding intra-frame (e.g., an I-frame 225), a predicted-frame (e.g., a P-frame 235), or a bi-directional predicted frame (e.g., a B-frame 225) in a video frame sequence 220. The device 115 may estimate second motion vector information of the frame (e.g., a P-frame 235) associated with the set of video frames based on a learning model (e.g., the machine learning component 215-a, the machine learning component 215-b) and compare the first motion vector information and the second motion vector information using the learning model. In some aspects, the device 115 may generate a set of video packets carrying the set of video frames including the video frame based on the comparing, where the video frame (e.g., the P-frame 235) is generated at the device 115 or the video frame is generated at a second device 115 (e.g., the device 115-b) in wireless communication with the device 115. In some aspects, the device 115 may transmit a video data stream 205 including the set of video packets.

The device 115 may generate a first subset of video frames (e.g., a subset of one or more P-frames 235) of the set of video frames (e.g., the I-frames 225, B-frames 230, and P-frames 235) based on the comparing. In some aspects, the device 115 may refrain from generating a second subset of video frames (e.g., a second subset of one or more P-frames 235) of the set of video frames based on the comparing, and the second subset of video frames (e.g., the second subset of one or more P-frames 235) may be generated at the second device 115 (e.g., the device 115-b) in wireless communication with the device 115. In some aspects, in generating the set of video packets, the device 115 may exclude data associated with the frame based on the comparing.

The device 115 may transmit, to the second device 115 over a wireless connection, the set of video packets based on the generating. In some aspects, the device 115 may transmit, in the set of video packets, one or more of control information or data (e.g., frame data) associated with each video frame of the set of video frames (e.g., each of the I-frames 225, B-frames 230, and P-frames 235). The control information may include, for example, header information. In some aspects, the device 115 may refrain from transmitting, to the second device 115 over the wireless connection, a subset of video frames of the set of video frames, including the frame associated with the set of video frames, based on the generating. In some aspects, refraining from transmitting the subset of video frames may include excluding data associated with each video frame of the subset of video frames (e.g., excluding data associated with each of the I-frames 225, B-frames 230, and P-frames 235), including the frame (e.g., the P-frame 235) associated with the set of video frames. In some examples, the device 115 may transmit, in the set of video packets, control information associated with each video frame of the subset of video frames (e.g., control information associated with each of the I-frames 225, B-frames 230, and P-frames 235), including the frame associated with the set of video frames (e.g., the P-frame 235). The control information may include, for example, header information.

According to examples of aspects described herein, the device 115 may receive a second set of video packets (e.g., a second set of video packets included in a different video stream 205) associated with a second set of video frames (e.g., a second set of I-frames 225, B-frames 230, and P-frames 235), the second set of video packets including header information associated with a frame (e.g., a P-frame 225) of the second set of video frames. The device 115 may decode the second set of video packets based on the header information. In some aspects, the header information may include a discard signal, aspects of which are described herein. In some aspects, decoding the second set of video packets may include generating, based on the header information, data associated with the frame of the second set of video frames using the learning model (e.g., the machine learning component 215-a). In some examples, decoding the second set of video packets may include generating, based on the header information, motion vector information associated with the frame of the second set of video frames using the learning model (e.g., the machine learning component 215-a).

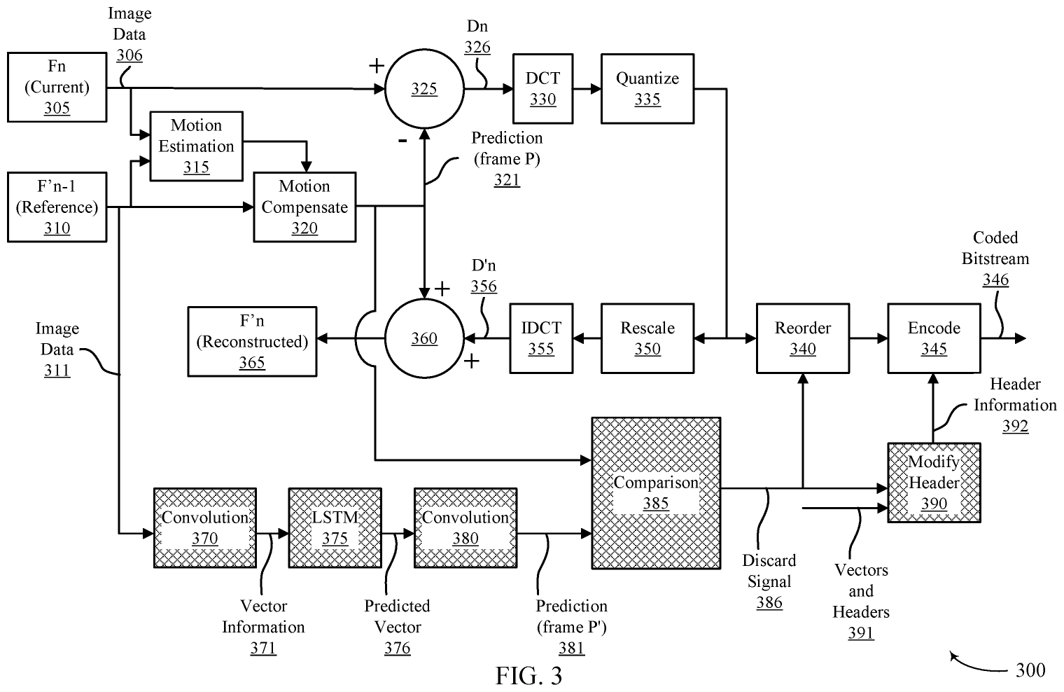

FIG. 3 illustrates an example of a process flow 300 for efficient bandwidth usage during video communications in accordance with aspects of the present disclosure. In some examples, the process flow 300 may support deep-learning integrated into video encoding. In some examples, the process flow 300 may implement aspects of the systems 100 and 200. The process flow 300 may be implemented, for example, by a device 115 (e.g., the device 115-a). The process flow 300 may be implemented by a processor of the device 115. In some aspects, the process flow 300 may include an encoder model and an integrated learning model (e.g., deep-learning integration with the encoder model) for P-frame generation.

According to aspects of the process flow 300, the device 115 may process a set of video frames. The set of frames may include video frames captured, for example, by a capturing component (e.g., a camera) of the device 115. For example, the set of frames may include video frames associated with video captured by the capturing component (e.g., a camera) of the device 115. At 305, the device 115 may identify an input frame Fₙ for encoding, for example, from the set of a video frames. The frame Fₙ may be, for example, a current video frame. The frame Fₙ may be, for example, a P-frame (e.g., a P-frame 235). In some aspects, the device 115 may process image data 306 associated with the frame Fₙ (e.g., process macroblocks of the frame Fₙ). At 310, the device 115 may identify a reference frame F′ₙ₋₁. The reference frame F′ₙ₋₁ may be a preceding reference frame with respect to the frame Fₙ. For example, the reference frame F′ₙ₋₁ may be a preceding I-frame 225, a preceding B-frame 230, or a preceding P-frame 235.

At 315, the device 115 may perform motion estimation to identify a macroblock in the reference frame F′ₙ₋₁ that matches a current macroblock in the frame Fₙ. In some aspects, the device 115 may perform one or more block matching algorithms to identify a macroblock in the reference frame F′ₙ₋₁ matching the current macroblock in the frame Fₙ, for example, based on image data 311 of the reference frame F′ₙ₋₁ (e.g., based on pixels of macroblocks in the reference frame F′ₙ₋₁) and image data 306 of the frame Fₙ (e.g., based on pixels of macroblocks in the frame Fₙ). The block matching algorithms may include a search area based on a search parameter such as, for example, a measure of motion associated with macroblocks. In some aspects, the device 115 may determine motion vector information associated with a macroblock based on a position of the current macroblock in the frame Fₙ and a position of the macroblock in the reference frame F′ₙ₋₁ (e.g., based on an offset between the position of the current macroblock in the frame Fₙ and the position of the macroblock in the reference frame F′ₙ₋₁). Each macroblock may include a number of samples (e.g., 8×8 samples, 16×16 samples). Each macroblock may be divided into transform blocks, and further subdivided into prediction blocks.

At 320, the device 115 may perform a motion compensation operation to generate a prediction 321. The prediction 321 may be referred to, for example, as motion vector information P. In some aspects, the prediction 321 (e.g., motion vector information P) may be associated with the frame Fₙ and the reference frame F′ₙ₋₁ (e.g. motion vector information of an object included in both the frame Fₙ and the reference frame F′ₙ₋₁). In some examples, at 320, the device 115 may generate the prediction 321 associated with the current frame Fₙ, for example, based on the reference frame F′ₙ₋₁ and the motion vector information (e.g., macroblock motion vector information) determined at 315. In some examples, the prediction 321 may include motion vector information of, for example, a P-frame (e.g., a P-frame 235).

At 325, the device 115 may subtract the prediction 321 (e.g., motion vector information P) from the frame Fₙ (e.g., from an input signal associated with producing the frame Fₙ). In some examples, the device 115 may output a signal 326. The signal 326 may include, for example, data Dₙ associated with the frame Fₙ. At 330, the device 115 may compress the data Dₙ included in the signal 326, for example, using block compression. In some examples, the device 115 may compress the data Dₙ using discrete cosine transform (DCT) compression. In some aspects, at 330, the device 115 may compress the data Dₙ in sets of DCT blocks. At 330, for example, the device 115 may output DCT coefficients based on the compression.

At 335, the device 115 may quantize data associated with the DCT coefficients output at 330. The device 115 may output the quantized data to the reordering 340 and encoding 345 of the process flow 300. In some aspects, the quantization may include compression techniques for compressing a range of values based on a quantum value. The quantization, for example, may include color quantization (e.g., reducing the number of colors used in an image) or frequency quantization (e.g., reducing data associated with compressing the image by reducing or ignoring high frequency components). At 340, the device 115 may reorder frames resulting from the quantization at 335. For example, at 340, the device 115 may order frames resulting from the quantization at 335 based on an encoding order (e.g., an order in which the device 115 may encode the frames at 345).

At 345, the device 115 may encode the frames output at 340, for example, based on the reordering. In some examples, the device 115 may encode the frames using a coding technique (e.g., entropy encoding). At 345, the device 115 may output a coded bitstream 346 associated with the set of video frames processed and generated in the process flow 300. In an example, the coded bitstream 346 may include a set of video packets carrying the set of video frames. Aspects of the coded bitstream 346 may include examples of aspects of the video data stream 205 described herein. In some aspects, at 350 through 365, the device 115 may implement one or more techniques for image or frame reconstruction, for example, using rescaling (e.g., dequantization) and inverse DCT (IDCT) operations. For example, at 350 through 365, the device 115 may reconstruct the set of video frames using reconstruction techniques also to be used at a decoding device (e.g., a device 115 receiving the coded bitstream 346). For example, at 350, the device 115 may perform a rescaling operation. In some examples, the device 115 may rescale the quantized data output by the quantization at 335. At the rescaling at 350, for example, the device 115 may dequantize the data output by the quantization at 335. At 350, for example, the device 115 may perform an inverse quantization.

At 355, the device 115 may perform an inverse DCT (IDCT) operation. In some aspects, at 355, the IDCT operation may include transforming the data output by the rescaling (e.g., dequantization, inverse quantization) performed at 350. For example, the device 115 may transform DCT coefficients (e.g., output by the DCT operation at 330 and quantization at 335) based on a transformation inverse to the DCT at 330. In some examples, at the IDCT of 355, the device may output a signal 356. The signal 356 may include, for example, data n associated with the frame Fₙ. In some aspects, the data D′ₙ may include a prediction residual. In some aspects, the data D′ₙ may correspond to data predicted to be generated at a decoding device (e.g., a device 115 receiving the coded bitstream 346).

At 360, the device 115 may sum or add the prediction 321 (e.g., the motion vector information P) with the signal 356 (e.g., the data n), and in some aspects, output a frame 365 based on the summation. The frame 365 may be a reconstructed frame F′ₙ corresponding to the input frame Fₙ. The reconstructed frame F′ₙ may be a prediction of a reconstruction of the input frame Fₙ by a decoding device (e.g., a device 115 receiving the coded bitstream 346), for example, a prediction of how the decoding device may reconstruct the input frame Fₙ or motion vectors associated with the input frame Fₙ.

At 370 through 390 described herein, the device 115 may implement aspects of on-chip neural processing which may enhance processing of other subsystems of the device 115. For example, aspects of the on-chip neural processing may enhance processing associated with encoding at 345, as described herein. In some aspects, the on-chip neural processing by the device 115 may include using a learning model. The learning model, for example, may be implemented as part of a learning network included in the device 115 (e.g., machine learning component 155, machine learning component 215-a or 215-b). The learning network, for example, may include a machine learning network, a neural network, a deep neural network, an LSTM network, or a convolutional neural network. In an example, the learning network may include a recurrent neural network architecture such as a convolutional neural network LSTM (CNN LSTM). For example, the learning network may include a combination of convolutional layers and LSTM layers. In some aspects, at 370 through 380, the device 115 may generate a prediction 381 (e.g., a motion vector information P′ corresponding to the frame P). The device 115 may generate the prediction 381 (e.g., the motion vector information P′) for any time t, for example, based on a reference frame (e.g., the reference frame F′ₙ₋₁) at a time t−1.

At 370, the device 115 may process the image data 311 associated with the reference frame F′ₙ₋₁, for example, using convolution techniques utilizing one or more convolutional layers. In some aspects, at 370, the device 115 may output vector information 371 associated with the image data 311. At 375, the device 115 may process a vectored input (e.g., the vector information 371) using LSTM. In some aspects, the LSTM may include a LSTM neural network having improved prediction accuracy, for example, as prediction at a given time may refer to the context of a video sequence (e.g., the video frame sequence 220). In some aspects, at 375, the device 115 may generate predicted vectors 376 based on the vectored input. At 380, the device 115 may process the predicted vectors 376, for example, using convolution techniques utilizing one or more convolutional layers. In some aspects, at 380, the device 115 may output a prediction 381. In some aspects, the prediction 381 may include motion vector information P′ (e.g., of a predicted frame) corresponding to the motion vector information P (e.g., of the current frame Fₙ).

At 385, the device 115 may compare the prediction 381 (e.g., the motion vector information P′) to the prediction 321 (e.g., the motion vector information P). In some aspects, the device 115 may utilize the machine learning component 155 (e.g., a convolutional neural network) to compare the prediction 381 (e.g., motion vector information P′) to the prediction 321 (e.g., motion vector information P). For example, the device 115 may compare an accuracy level (e.g., prediction match) of the prediction 381 (e.g., motion vector information P′) and an accuracy level (e.g., prediction match) of the prediction 321 (e.g., motion vector information P). The device 115 may determine whether a difference between the accuracy level (e.g., prediction match) of the prediction 381 (e.g., motion vector information P′) and the accuracy level (e.g., prediction match) of the prediction 321 (e.g., motion vector information P) satisfies a threshold. In some aspects, the device 115 may output an indication (e.g., discard signal 386) based on determining whether the difference satisfies a threshold.

According to examples of aspects herein, during the comparing at 385, where the device 115 determines the difference satisfies the threshold (e.g., the difference between the accuracy level of the prediction 381 and the accuracy level of the prediction 321 is within the threshold), the device 115 may set the discard signal 386 to a value indicating that the device 115 is discarding the data associated with the input frame Fₙ (e.g., set the discard signal 386 to a value indicating that the device 115 is excluding transmitting the data associated with the input frame Fₙ). In another example, during the comparing at 385, where the device 115 determines the difference fails to satisfy the threshold (e.g., the difference is greater than the threshold), the device 115 may set the discard signal 386 to a value indicating that the device 115 is not discarding the data associated with the input frame Fₙ (e.g., set the discard signal 386 to a value indicating that the device 115 is transmitting the data associated with the input frame Fₙ).

At 390, the device 115 may include the discard signal 386 within header information. For example, at 390, the device 115 may modify header information of a video frame (e.g., the frame Fₙ) or a set of video frames. In an example, the device 115 may append the discard signal 386 to the header information. At 390, for example, the device 115 may receive vectors and headers 391. The device 115 may modify header information of one or more of the headers included in the vectors and headers 391. The device 115 may output modified header information 392.

Referring back to the reordering at 340 and the encoding at 345, according to examples of aspects herein, the device 115 may include the discard signal 386, for example, within the coded bitstream 346. When reordering at 340, for example, based on the value of the discard signal 386, the device 115 may exclude data (e.g., frame data) associated with the frame Fₙ.

At the encoding at 345, for example, based on the value of the discard signal 386, the device 115 may include control information (e.g., the discard signal 386, modified header information 392) associated with input frame Fₙ and exclude the data (e.g., frame data) associated with the input frame Fₙ, for example, as part of the encoding. In some aspects, the discard signal 386 may include an indication that the device 115 has discarded the data associated with the input frame Fₙ (e.g., an indication that the device 115 has excluded the data associated with the input frame Fₙ). In some aspects, the discard signal 386 may include an indication to a receiving device 115 (e.g., device 115-b) to use a learning model (e.g., on-chip neural processing of the device 115-b) to generate data (e.g., frame data) associated with one or more frames included in a video data stream (e.g., video data stream 205) transmitted by the device 115. For example, the discard signal 386 may include an indication to a receiving device 115 (e.g., device 115-b) to use a learning model to generate data (e.g., frame data) of the video frame (e.g., the frame Fₙ).

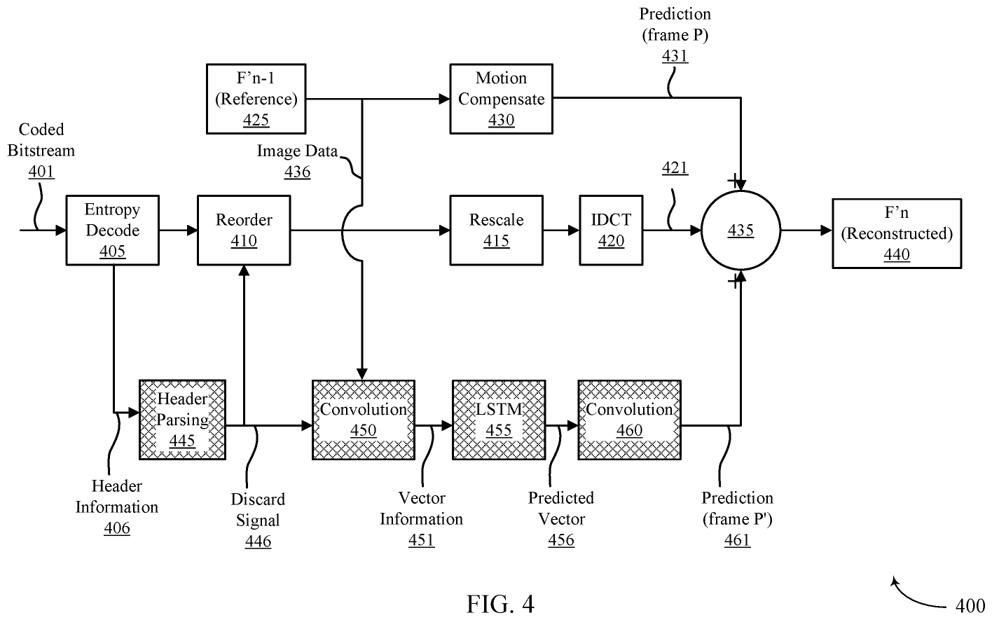

FIG. 4 illustrates an example of a process flow 400 for efficient bandwidth usage during video communications in accordance with aspects of the present disclosure. In some examples, the process flow 400 may support deep-learning integrated into video encoding. In some examples, the process flow 400 may implement aspects of the systems 100 and 200. The process flow 400 may be implemented, for example, by a device 115 (e.g., a device 115-b in wireless communication with the device 115-a). The process flow 400 may be implemented by a processor of the device 115. In some aspects, the process flow 400 may include a decoder model and an integrated learning model (e.g., deep-learning integration with the decoder model) for P-frame generation.

The device 115 (e.g., the device 115-b) may process a video data stream (e.g., a coded bitstream 401) received by the device 115. The coded bitstream 401 may include video frames captured, for example, by a capturing component (e.g., a camera) of another device 115 (e.g., the device 115-a). The coded bitstream 401 may be a bitstream generated by encoding (e.g., entropy encoding) at the other device 115, and for example, may include a set of video packets carrying the set of video frames. In some aspects, the device 115 may receive the coded bitstream 401 from the other device 115 via wireless communication or wired communication. Aspects of the coded bitstream 401 may include aspects of the video data stream 205 and the coded bitstream 346 described herein.

At 405, the device 115 may decode the coded bitstream 401. In some examples, the device 115 may decode frames included in the coded bitstream 401 using a coding technique (e.g., entropy decoding). At 405, the device 115 may output or reconstruct a set of video frames (e.g., a frame sequence) carried by the video packets included in the coded bitstream 401. In some aspects, at 405, the device 115 may output header information 406 associated with each of the video frames. In some aspects, entropy decoding may include decoding a zig-zag sequence of quantized DCT coefficients.

At 410, the device 115 may set or adjust the order of the set of video frames based on the decoding at 405. For example, at 410, the device 115 may set or adjust the order of the set of video frames according to a rescaling order or a display or rendering order (e.g., an order in which the device 115 may display or render the frames). In some aspects, the order in which the device 115 may rescale the frames or render or display the frames may differ from the order in which the device 115 decodes the frames at 405. In some aspects, at 415 through 440, the device 115 may implement one or more techniques for image or frame reconstruction based on the coded bitstream 401, for example, using rescaling (e.g., dequantization) and inverse DCT (IDCT) operations. For example, at 415, the device 115 may perform a rescaling operation. In some examples, the device 115 may rescale the video frames (e.g., frame data) following the reordering at 410. At the rescaling at 415, for example, the device 115 may dequantize any quantized data included in video frames (e.g., frame data). At 415, the device 115 may perform an inverse quantization.

At 420, the device 115 may perform an IDCT operation. In some aspects, at 420, the IDCT operation may include transforming the data output by the rescaling (e.g., dequantization, inverse quantization) performed at 415. For example, the device 115 may transform DCT coefficients of data included in the coded bitstream 401. At 420, the device 115 may output a signal 421 based on the IDCT operation. In some examples, the device 115 may perform the IDCT operation following the rescaling at 415. In some aspects, the IDCT operation at 420 may include transforming the DCT coefficients according to samples having a block size of 8×8.

At 425, the device 115 may identify a reference frame F′ₙ₋₁ associated with a current frame Fₙ of the coded bitstream 401. The reference frame F′ₙ₋₁ may be a preceding reference frame with respect to the current frame Fₙ. For example, the frame Fₙ may be a P-frame 235, and the reference frame F′ₙ₋₁ may be a preceding I-frame 225, a B-frame 230, or a P-frame 235. At 425, the device 115 may. determine image data 436 (e.g., frame data) associated with the reference frame F′ₙ₋₁.

At 430, the device 115 may perform a motion compensation operation to generate a prediction 431. The prediction 431 may be referred to, for example, as motion vector information P. In some aspects, the prediction 431 (e.g., motion vector information P) may be associated with the current frame Fₙ of the set of video frames of the bitstream 401 and the reference frame F′ₙ₋₁ (e.g. motion vector information of an object included in both the frame Fₙ and the reference frame F′ₙ₋₁). In some examples, at 430, the device 115 may generate the prediction 431 (e.g., motion vector information P), for example, based on the reference frame F′ₙ₋₁ (e.g., based on the image data 436 of the reference frame F′ₙ₋₁) and the motion compensation information determined at 430. In some examples, the prediction 431 (e.g., motion vector information P) may include motion vector information of, for example, a P-frame (e.g., the current frame Fₙ may be a P-frame 235).

At 435, the device 115 may sum or add the prediction 431 (e.g., motion vector information P) with the signal 421, and in some aspects, output a frame 440 based on the summation. The frame 440 may be a reconstructed frame F′ₙ corresponding to the current frame Fₙ included in the coded bitstream 401 and being decoded by the device 115.

At 445 through 460 described herein, the device 115 may implement aspects of on-chip neural processing which may enhance processing of other subsystems of the device 115. For example, aspects of the on-chip neural processing may enhance processing associated with decoding at 405, as well as frame reconstruction and prediction, as described herein. In some aspects, the on-chip neural processing by the device 115 may include using a learning model. The learning model, for example, may be implemented as part of a learning network included in the device 115 (e.g., machine learning component 155, machine learning component 215-b). The learning network, for example, may include a machine learning network, a neural network, a deep neural network, an LSTM network, or a convolutional neural network. In an example, the learning network may include a recurrent neural network architecture such as CNN LSTM. For example, the learning network may include a combination of convolutional layers and LSTM layers.

In some aspects, at 445 through 460, the device 115 may generate a prediction 461 (e.g., a motion vector information P′ corresponding to the current frame Fₙ of the coded bitstream 401). The device 115 may generate the prediction 461 (e.g., the motion vector information P′) for any time t, for example, based on a reference frame (e.g., based on the reference frame F′ₙ₋₁) at a time t−1 with respect to the current frame Fₙ. The frame generation control flow using neural processing at the decoder model (e.g., convolution at 450, LSTM at 455, and convolution at 460) may include examples of aspects of the frame generation control flow using neural processing at the encoder model (e.g., convolution at 370, LSTM at 375, and convolution at 380).

At 445, the device 115 may parse the header information 406 determined during the decoding at 405. In some examples, during the header parsing at 445, the device 115 may identify a discard signal 446 included header information associated with each of the video frames. The discard signal 446 may include examples of aspects of the discard signal 386 described herein. For example, the discard signal 466 may include an indication for the device 115 (e.g., the device 115-b) to use a learning model (e.g., on-chip neural processing of the device 115-b) to generate data (e.g., frame data) associated with one or more frames included in the video data stream (e.g., video data stream 205) received by the device 115.

The discard signal 446 may include an indication to the device 115 (e.g., the device 115-b) to use a learning model to generate data (e.g., frame data) of the current frame Fₙ of the coded bitstream 401. For example, the device 115 may process video frames using a learning model (e.g., on-chip neural processing, neural network prediction), or without using the learning model, based on the discard signal 446. For example, the device 115 may determine, based on the discard signal 446, whether P-frame generation was discarded at the other device 115 (e.g., the device 115-a) at the time of encoding. In an example where the discard signal 446 indicates P-frame generation was discarded at the other device 115 (e.g., the device 115-a) at the time of encoding, the device 115 (e.g., the device 115-b) may process the video frames using the learning model. For example, the device 115 may generate the prediction 461 (e.g., the motion vector information P′) using a combination of convolution layers and LSTM (e.g., using convolution 445, LSTM 455, and convolution 460).

At 450, the device 115 may process the image data 436 associated with the reference frame F′ₙ₋₁, for example, using convolution techniques utilizing one or more convolutional layers. In some aspects, at 450, the device 115 may output vector information 451 associated with the image data 436. The convolution techniques included at 450 may be examples of aspects of the convolution techniques at 370.

At 455, the device 115 may process a vectored input (e.g., the vector information 451) using LSTM. The LSTM at 455 may include examples of aspects of the LSTM at 375. In some aspects, at 455, the device 115 may generate predicted vectors 456 based on the vectored input. In some example aspects, the LSTM at 455 may include features for learning a current frame Fₙ regardless of the discard signal 446 (e.g., regardless of whether the header information 406 includes a discard signal 446) or a value of the discard signal 446 (e.g., regardless of whether the discard signal 446 indicates to the device 115 to generate the prediction 461 (e.g., the motion vector information P′).

For example, the LSTM at 455 may include features for learning each reconstructed frame 440 (e.g., each reconstructed frame F′ₙ corresponding to the current frame Fₙ). The LSTM at 455 may include features for determining, based on the discard signal 446, whether to output a neural network prediction (e.g., the prediction 461, for example, the motion vector information P′). In an example, if the device 115 determines that the header information 406 does not include a discard signal 446, then the device 115 (e.g., at the LSTM at 455) may determine not to output a neural network prediction. Alternatively, or additionally, the device 115 may determine to output a neural network prediction or not output a neural network prediction, based on a value of the discard signal 446.

At 460, the device 115 may process the predicted vectors 456, for example, using convolution techniques utilizing one or more convolutional layers. In some aspects, at 460, the device 115 may output a prediction 461 (e.g., motion vector information P′). In some aspects, the prediction 461 may correspond to the current frame Fₙ. The convolution techniques included at 460 may be examples of aspects of the convolution techniques at 380.

Referring back to the reordering at 410, the rescaling at 415, and the IDCT at 420, and the summation at 435, according to examples of aspects herein, the device 115 (e.g., the device 115-b) may reorder, rescale, and perform IDCT based on values of discard signals 446 associated with video frames of the coded bitstream 401 (e.g., video frames carried by video packets of the coded bitstream 401). In some aspects, the device 115 may generate a set of video frames (e.g., a frame sequence) based on the prediction 431 (e.g., motion vector information P), the signal 421 (e.g., frames generated based on the decoding 405, reordering 410, rescaling 415, and IDCT 420), and the prediction 461 (e.g., motion vector information P′) by the learning network.

At 410, for example, based on the value of the discard signal 446 associated with the current frame Fₙ, the device 115 may set or adjust the decoding order associated with decoding the set of video frames (e.g., the frame sequence) included in the coded bitstream 401. For example, where the discard signal 446 associated with the current frame Fₙ indicates that P-frame generation was discarded at the other device 115 (e.g., the device 115-a) at the time of encoding, the device 115 (e.g., the device 115-b) may generate the current frame Fₙ or the prediction 431 (e.g., motion vector information P associated with the current frame Fₙ) using the learning model. In some aspects, the device 115 may set or adjust the further processing order (e.g., rescaling order, display or rendering order) of the set of video frames (e.g., the frame sequence) to be processed using rescaling at 415 and IDCT 420. For example, the device 115 may set or adjust the order for generating the video frames using the learning model (e.g., using convolution 445, LSTM 455, and convolution 460).

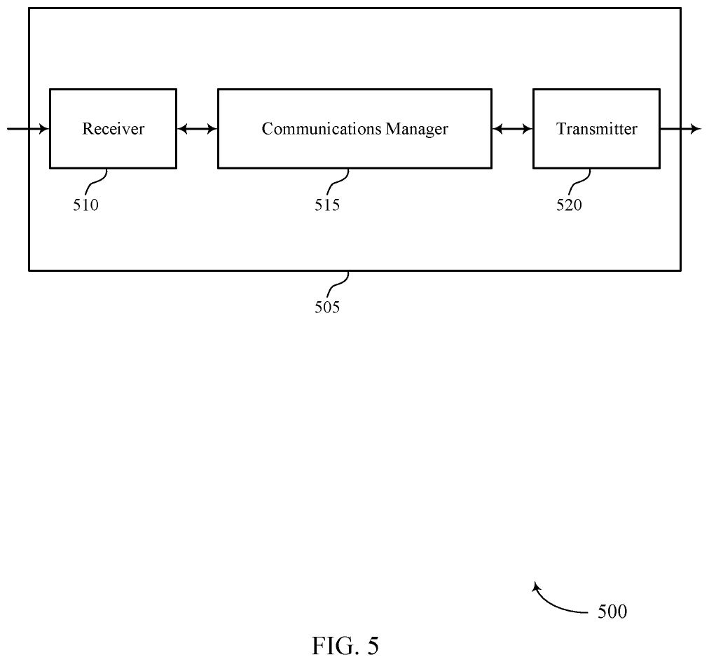

FIG. 5 shows a block diagram 500 of a device 505 that supports efficient bandwidth usage during video communications in accordance with aspects of the present disclosure. The device 505 may be an example of aspects of a device as described herein. The device 505 may include a receiver 510, a communications manager 515, and a transmitter 520. The device 505 may also include a processor. Each of these components may be in communication with one another (e.g., via one or more buses).

The receiver 510 may receive information such as packets, user data, or control information associated with various information channels (e.g., control channels, data channels, and information related to efficient bandwidth usage during video communications, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may estimate first motion vector information of a frame associated with a set of video frames based on a reference frame associated with the set of video frames, where the reference frame includes a preceding intra-frame, a predicted-frame, or a bi-directional predicted frame in a video frame sequence, estimate second motion vector information of the frame associated with the set of video frames based on a learning model, compare the first motion vector information and the second motion vector information using the learning model, and generate a set of video packets carrying the set of video frames including the video frame based on the comparing, where the video frame is generated at the device 505 or the video frame is generated at a second device in wireless communication with the device 505. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

The communications manager 515 as described herein may be implemented to realize one or more potential advantages. One implementation may allow the device 505 to provide techniques which may support efficient bandwidth usage during video communications, among other advantages. For example, the device 505 may include features for high-resolution video streaming and efficient bandwidth usage of the network, as the device 505 may use a learning model to reduce the amount of frames (e.g., P-frames) streamed over a network. Additionally or alternatively, the device 505 may include features for promoting enhanced efficiency and low latency for multimedia operations (e.g., audio streaming, video streaming), among other benefits, which may support improvements to power consumption, spectral efficiency, higher data rates, as the device 505 may generate a first subset of video frames at the device 505 while refraining from generating a second subset of video frames at the device 505, such that the second subset of video frames may be generated at a second device in wireless communication with the device 505. The communications manager 515 may be an example of aspects of the communications manager 810 described herein.

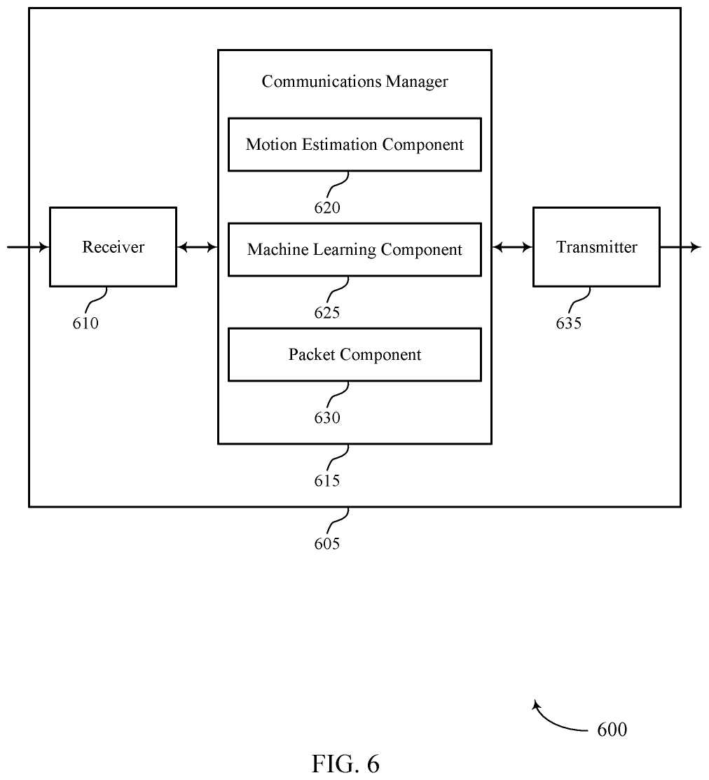

FIG. 6 shows a block diagram 600 of a device 605 that supports efficient bandwidth usage during video communications in accordance with aspects of the present disclosure. The device 605 may be an example of aspects of a device 505 or a device 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to efficient bandwidth usage during video communications, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a motion estimation component 620, a machine learning component 625, and a packet component 630. The communications manager 615 may be an example of aspects of the communications manager 810 described herein. The motion estimation component 620 may estimate first motion vector information of a frame associated with a set of video frames based on a reference frame associated with the set of video frames, where the reference frame includes a preceding intra-frame, a predicted-frame, or a bi-directional predicted frame in a video frame sequence. The machine learning component 625 may estimate second motion vector information of the frame associated with the set of video frames based on a learning model and compare the first motion vector information and the second motion vector information using the learning model. The packet component 630 may generate a set of video packets carrying the set of video frames including the video frame based on the comparing, where the video frame is generated at the device 605 or the video frame is generated at a second device in wireless communication with the device 605.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

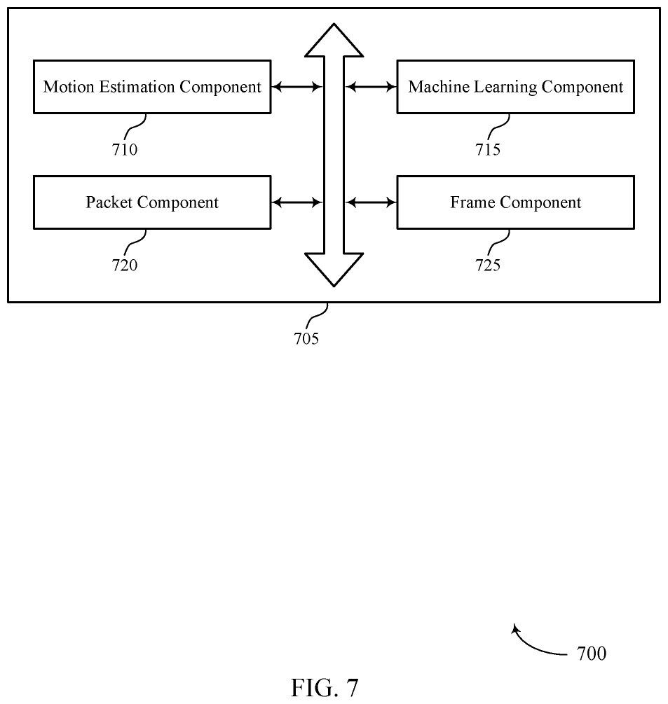

FIG. 7 shows a block diagram 700 of a communications manager 705 that supports efficient bandwidth usage during video communications in accordance with aspects of the present disclosure. The communications manager 705 may be an example of aspects of a communications manager 515, a communications manager 615, or a communications manager 810 described herein. The communications manager 705 may include a motion estimation component 710, a machine learning component 715, a packet component 720, and a frame component 725. Each of these modules may communicate, directly or indirectly, with one another (e.g., via one or more buses).

The motion estimation component 710 may estimate first motion vector information of a frame associated with a set of video frames based on a reference frame associated with the set of video frames, where the reference frame includes a preceding intra-frame, a predicted-frame, or a bi-directional predicted frame in a video frame sequence. The machine learning component 715 may estimate second motion vector information of the frame associated with the set of video frames based on a learning model. In some examples, the machine learning component 715 may compare the first motion vector information and the second motion vector information using the learning model. In some examples, the machine learning component 715 may determine a difference between an accuracy level of the first motion vector information and an accuracy level of the second motion vector information.

In some examples, the machine learning component 715 may determine that the difference satisfies a threshold, where generating the set of video packets is based on the difference satisfying the threshold. In some examples, the data associated with the subset of video frames may be generated at the second device in wireless communication with the device. In some examples, the machine learning component 715 may generate, based on the header information, data associated with the frame of the second set of video frames using the learning model. In some examples, the machine learning component 715 may generate, based on the header information, motion vector information associated with the frame of the second set of video frames using the learning model. In some cases, the indication signals to render the data associated with each video frame of the subset of video frames, including the frame associated with the set of video frames, using the learning model. In some cases, the learning model includes a machine learning network, a neural network, long short-term memory network, or a convolutional neural network.

The packet component 720 may generate a set of video packets carrying the set of video frames including the video frame based on the comparing, where the video frame is generated at the device or the video frame is generated at a second device in wireless communication with the device. In some examples, transmitting, to the second device over a wireless connection, the set of video packets based on the generating, where transmitting the set of video packets includes transmitting, in the set of video packets, one or more of control information or data associated with each video frame of the set of video frames. In some examples, transmitting, in the set of video packets, control information associated with each video frame of the subset of video frames, including the frame associated with the set of video frames, where the control information includes header information. In some examples, the packet component 720 may refrain from encoding data associated with a subset of video frames of the set of video frames, including the frame associated with the set of video frames, based on the difference satisfying the threshold.

In some examples, the packet component 720 may modify header information of the subset of video frames of the set of video frames, including the frame associated with the set of video frames, based on the comparing. In some examples, the packet component 720 may append, to the header information, an indication that the data associated with each video frame of the subset of video frames of the set of video frames, including the frame associated with the set of video frames is discarded. In some examples, generating the set of video packets includes excluding data associated with the frame based on the comparing. In some examples, the packet component 720 may receive a second set of video packets associated with a second set of video frames, the second set of video packets including header information associated with a frame of the second set of video frames. In some examples, the packet component 720 may decode the second set of video packets based on the header information.

The frame component 725 may generate, at the device, a first subset of video frames of the set of video frames based on the comparing. In some examples, the frame component 725 may refrain from generating, at the device, a second subset of video frames of the set of video frames based on the comparing, where the second subset of video frames is generated at the second device in wireless communication with the device. In some examples, frame component 725 may refrain from transmitting, to the second device over a wireless connection, a subset of video frames of the set of video frames, including the frame associated with the set of video frames, based on the generating, where the refraining from transmitting the subset of video frames includes excluding data associated with each video frame of the subset of video frames, including the frame associated with the set of video frames.

FIG. 8 shows a diagram of a system 800 including a device 805 that supports efficient bandwidth usage during video communications in accordance with aspects of the present disclosure. The device 805 may be an example of or include the components of device 505, device 605, or a device as described herein. The device 805 may include components for bi-directional voice and data communications including components for transmitting and receiving communications, including a communications manager 810, an I/O controller 815, a transceiver 820, an antenna 825, memory 830, a processor 840, and a coding manager 850. These components may be in electronic communication via one or more buses (e.g., bus 845).

The communications manager 810 may estimate first motion vector information of a frame associated with a set of video frames based on a reference frame associated with the set of video frames, where the reference frame includes a preceding intra-frame, a predicted-frame, or a bi-directional predicted frame in a video frame sequence, estimate second motion vector information of the frame associated with the set of video frames based on a learning model, compare the first motion vector information and the second motion vector information using the learning model, and generate a set of video packets carrying the set of video frames including the video frame based on the comparing, where the video frame is generated at the device 805 or the video frame is generated at a second device in wireless communication with the device 805. As detailed above, the communications manager 810 and/or one or more components of the communications manager 810 may perform and/or be a means for performing, either alone or in combination with other elements, one or more operations for supporting efficient bandwidth usage during video communications.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS, ANDROID, MS-DOS, MS-WINDOWS, OS/2, UNIX, LINUX, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the device 805 may include a single antenna 825. However, in some cases, the device 805 may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The code 835 may include instructions to implement aspects of the present disclosure, including instructions to support video communication. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting efficient bandwidth usage during video communications).

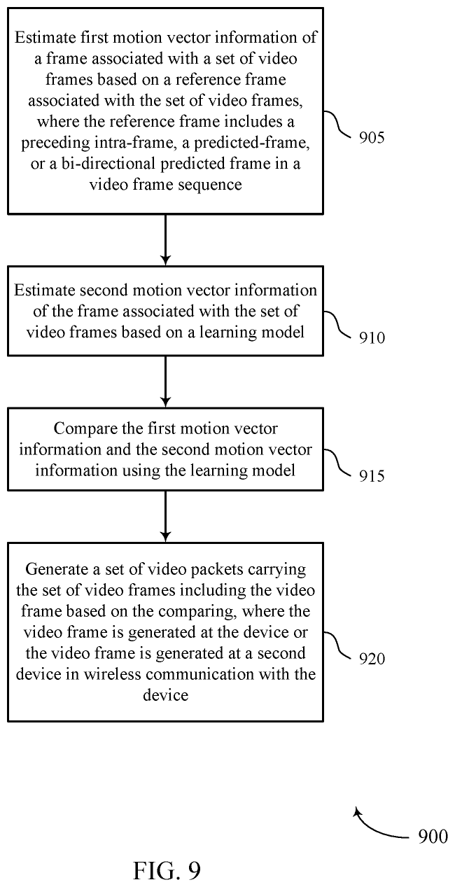

FIG. 9 shows a flowchart illustrating a method 900 that supports efficient bandwidth usage during video communications in accordance with aspects of the present disclosure. The operations of method 900 may be implemented by a device or its components as described herein. For example, the operations of method 900 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 905, the device may estimate first motion vector information of a frame associated with a set of video frames based on a reference frame associated with the set of video frames, where the reference frame includes a preceding intra-frame, a predicted-frame, or a bi-directional predicted frame in a video frame sequence. The operations of 905 may be performed according to the methods described herein. In some examples, aspects of the operations of 905 may be performed by a motion estimation component as described with reference to FIGS. 5 through 8.

At 910, the device may estimate second motion vector information of the frame associated with the set of video frames based on a learning model. The operations of 910 may be performed according to the methods described herein. In some examples, aspects of the operations of 910 may be performed by a machine learning component as described with reference to FIGS. 5 through 8.

At 915, the device may compare the first motion vector information and the second motion vector information using the learning model. The operations of 915 may be performed according to the methods described herein. In some examples, aspects of the operations of 915 may be performed by a machine learning component as described with reference to FIGS. 5 through 8.

At 920, the device may generate a set of video packets carrying the set of video frames including the video frame based on the comparing, where the video frame is generated at the device or the video frame is generated at a second device in wireless communication with the device. The operations of 920 may be performed according to the methods described herein. In some examples, aspects of the operations of 920 may be performed by a packet component as described with reference to FIGS. 5 through 8.

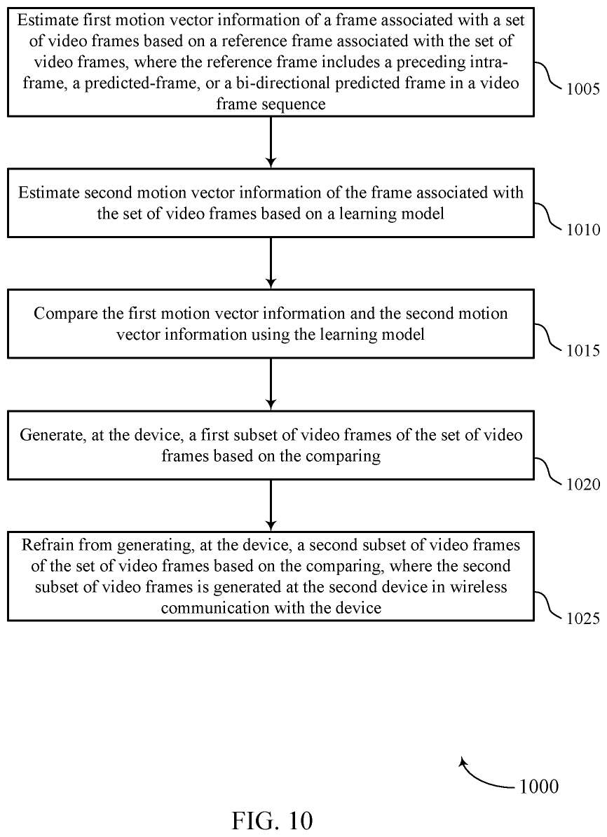

FIG. 10 shows a flowchart illustrating a method 1000 that supports efficient bandwidth usage during video communications in accordance with aspects of the present disclosure. The operations of method 1000 may be implemented by a device or its components as described herein. For example, the operations of method 1000 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1005, the device may estimate first motion vector information of a frame associated with a set of video frames based on a reference frame associated with the set of video frames, where the reference frame includes a preceding intra-frame, a predicted-frame, or a bi-directional predicted frame in a video frame sequence. The operations of 1005 may be performed according to the methods described herein. In some examples, aspects of the operations of 1005 may be performed by a motion estimation component as described with reference to FIGS. 5 through 8.

At 1010, the device may estimate second motion vector information of the frame associated with the set of video frames based on a learning model. The operations of 1010 may be performed according to the methods described herein. In some examples, aspects of the operations of 1010 may be performed by a machine learning component as described with reference to FIGS. 5 through 8.

At 1015, the device may compare the first motion vector information and the second motion vector information using the learning model. The operations of 1015 may be performed according to the methods described herein. In some examples, aspects of the operations of 1015 may be performed by a machine learning component as described with reference to FIGS. 5 through 8.

At 1020, the device may generate, at the device, a first subset of video frames of the set of video frames based on the comparing. The operations of 1020 may be performed according to the methods described herein. In some examples, aspects of the operations of 1020 may be performed by a frame component as described with reference to FIGS. 5 through 8.

At 1025, the device may refrain from generating, at the device, a second subset of video frames of the set of video frames based on the comparing, where the second subset of video frames is generated at the second device in wireless communication with the device. The operations of 1025 may be performed according to the methods described herein. In some examples, aspects of the operations of 1025 may be performed by a frame component as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for video communication at a device, comprising:
estimating first motion vector information of a frame associated with a set of video frames based at least in part on a reference frame associated with the set of video frames, wherein the reference frame comprises a preceding intra-frame, a predicted-frame, or a bi-directional predicted frame in a video frame sequence;
estimating second motion vector information of the frame associated with the set of video frames based at least in part on a learning model;
comparing the first motion vector information and the second motion vector information using the learning model; and
generating a set of video packets carrying the set of video frames including the video frame based at least in part on the comparing, wherein the video frame is generated at the device or the video frame is generated at a second device in wireless communication with the device, the set of video packets including an indication of an absence of a predicted frame associated with the set of video frames.

2. The method of claim 1, wherein generating the set of video packets carrying the set of video frames comprises:
generating, at the device, a first subset of video frames of the set of video frames based at least in part on the comparing; and
refraining from generating, at the device, a second subset of video frames of the set of video frames based at least in part on the comparing,
wherein the second subset of video frames is generated at the second device in wireless communication with the device.

3. The method of claim 1, further comprising:
transmitting, to the second device over a wireless connection, the set of video packets based at least in part on the generating, wherein transmitting the set of video packets comprises:
transmitting, in the set of video packets, one or more of control information or data associated with each video frame of the set of video frames.

4. The method of claim 1, further comprising:
refraining from transmitting, to the second device over a wireless connection, a subset of video frames of the set of video frames, including the frame associated with the set of video frames, based at least in part on the generating, wherein the refraining from transmitting the subset of video frames comprises:
excluding data associated with each video frame of the subset of video frames, including the frame associated with the set of video frames.

5. The method of claim 4, further comprising:
transmitting, in the set of video packets, control information associated with each video frame of the subset of video frames, including the frame associated with the set of video frames,
wherein the control information comprises header information.

6. The method of claim 1, wherein comparing the first motion vector information and the second motion vector information comprises:
determining a difference between an accuracy level of the first motion vector information and an accuracy level of the second motion vector information; and
determining that the difference satisfies a threshold, wherein generating the set of video packets is based at least in part on the difference satisfying the threshold.

7. The method of claim 6, further comprising:
refraining from encoding data associated with a subset of video frames of the set of video frames, including the frame associated with the set of video frames, based at least in part on the difference satisfying the threshold,
wherein the data associated with the subset of video frames is generated at the second device in wireless communication with the device.

8. The method of claim 6, further comprising:
modifying header information of the subset of video frames of the set of video frames, including the frame associated with the set of video frames, based at least in part on the comparing.

9. The method of claim 8, wherein modifying the header information comprises:
appending, to the header information, an indication that the data associated with each video frame of the subset of video frames of the set of video frames, including the frame associated with the set of video frames is discarded.

10. The method of claim 9, wherein the indication signals to render the data associated with each video frame of the subset of video frames, including the frame associated with the set of video frames, using the learning model.

11. The method of claim 1, wherein generating the set of video packets comprises:
excluding data associated with the frame based at least in part on the comparing.

12. The method of claim 1, wherein the learning model comprises a machine learning network, a neural network, long short-term memory network, or a convolutional neural network.

13. The method of claim 1, further comprising:
receiving a second set of video packets associated with a second set of video frames, the second set of video packets comprising header information associated with a frame of the second set of video frames; and
decoding the second set of video packets based at least in part on the header information.

14. The method of claim 13, wherein decoding the second set of video packets comprises:
generating, based at least in part on the header information, data associated with the frame of the second set of video frames using the learning model.

15. The method of claim 13, wherein decoding the second set of video packets comprises:
generating, based at least in part on the header information, motion vector information associated with the frame of the second set of video frames using the learning model.

16. An apparatus for video communication, comprising:
a processor, memory coupled with the processor; and instructions stored in the memory and executable by the processor to cause the apparatus to:
estimate first motion vector information of a frame associated with a set of video frames based at least in part on a reference frame associated with the set of video frames, wherein the reference frame comprises a preceding intra-frame, a predicted-frame, or a bi-directional predicted frame in a video frame sequence;
estimate second motion vector information of the frame associated with the set of video frames based at least in part on a learning model;
compare the first motion vector information and the second motion vector information using the learning model; and
generate a set of video packets carrying the set of video frames including the video frame based at least in part on the comparing, wherein the video frame is generated at the apparatus or the video frame is generated at a second apparatus in wireless communication with the apparatus, the set of video packets including an indication of an absence of a predicted frame associated with the set of video frames.

17. The apparatus of claim 16, wherein the instructions to generate the set of video packets carrying the set of video frames are executable by the processor to cause the apparatus to:
generate, at the apparatus, a first subset of video frames of the set of video frames based at least in part on the comparing; and
refrain from generating, at the apparatus, a second subset of video frames of the set of video frames based at least in part on the comparing, wherein the second subset of video frames is generated at the second apparatus in wireless communication with the apparatus.

18. The apparatus of claim 16, wherein the instructions are further executable by the processor to cause the apparatus to:
transmit, to the second apparatus over a wireless connection, the set of video packets based at least in part on the generating, wherein the instructions to transmit the set of video packets are executable by the processor to cause the apparatus to:
transmit, in the set of video packets, one or more of control information or data associated with each video frame of the set of video frames.

19. The apparatus of claim 16, wherein the instructions are further executable by the processor to cause the apparatus to:
receive a second set of video packets associated with a second set of video frames, the second set of video packets comprising header information associated with a frame of the second set of video frames; and
decode the second set of video packets based at least in part on the header information.

20. An apparatus for video communication, comprising:
means for estimating first motion vector information of a frame associated with a set of video frames based at least in part on a reference frame associated with the set of video frames, wherein the reference frame comprises a preceding intra-frame, a predicted-frame, or a bi-directional predicted frame in a video frame sequence; means for estimating second motion vector information of the frame associated with the set of video frames based at least in part on a learning model; means for comparing the first motion vector information and the second motion vector information using the learning model; and
means for generating a set of video packets carrying the set of video frames including the video frame based at least in part on the comparing, wherein the video frame is generated at the apparatus or the video frame is generated at a second apparatus in wireless communication with the apparatus, the set of video packets including an indication of an absence of a predicted frame associated with the set of video frames.
